(19) United States
(12) Patent Application Publication
(10) Pub. No.: US 2026/0253568 A1
(43) Pub. Date: Aug. 27, 2026

(54) INFORMATION PROCESSING METHOD AND INFORMATION PROCESSING SYSTEM

(71) Applicant: Yamaha Corporation, Hamamatsu (JP)

(72) Inventors: Akira MAEZAWA, Yokohama (JP); Kazuhiko YAMAMOTO, Sapporo (JP); Yixiao ZHANG, Santa Clara, CA (US)

(21) Appl. No.: 19/644,418

(22) Filed: Apr. 10, 2026

Related U.S. Application Data
(63) Continuation of application No. PCT/JP2024/036104, filed on Oct. 9, 2024.
(60) Provisional application No. 63/590,044, filed on Oct. 13, 2023.

(51) Int. Cl. G10H 1/00

(52) U.S. Cl. CPC G10H 1/0025; G10H 2210/105; G10H 2210/111

(57) ABSTRACT

An information processing method generates first instruction data, using a machine-learned generative model, based on first input data containing an instruction from a user regarding processing of music data, and attribute data representing an attribute of music represented by the music data, performs processing indicated by the first instruction data on the music data, using one or more processing models indicated by the first instruction data, generates second instruction data, using the generative model, based on second input data containing an instruction from the user regarding processing of the music data on which the processing indicated by the first instruction data has been performed, and the attribute data, and performs processing indicated by the second instruction data on the music data, using the one or more processing models indicated by the second instruction data.

### CROSS-REFERENCE TO RELATED APPLICATIONS

This application is a continuation application of PCT International Application No. PCT/JP2024/036104 filed on October 9, 2024, which claims the benefit of U.S. Provisional Applicaiton No. 63/590,044 filed on October 13, 2023. The entire disclosures of PCT International Application No. PCT/JP2024/036104 and U.S. Provisional Application No. 63/590,044 are hereby incorporated herein by reference.

### BACKGROUND

### Field of the Invention

The present disclosure relates to technology for processing music data.

### Background Information

Various technologies for generating music in response to user instructions have been proposed in the past. For example, Non-Patent Document 1 (Ryan Louie, Andy Coenen, Cheng Zhi Huang, Michael Terry, and Carrie J Cai, "Novice-AI music co-creation via AI-steering tools for deep generative models" In Proceedings of the 2020 CHI conference on human factors in computing systems. 1-13.), Non-Patent Document 2 (Simeon Rau, Frank Heyen, Stefan Wagner, and Michael Sedlmair, "Visualization for AI-Assisted Composing" In Proceedings of the 23rd International Society for Music Information Retrieval Conference.), and Non-Patent Document 3 (Adam Roberts, Jesse Engel, Yotam Mann, Jon Gillick, Claire Kayacik, Signe Norly, Monica Dinculescu, Carey Radebaugh, Curtis Hawthorne, and Douglas Eck, "Magenta Studio: Augmenting Creativity with Deep Learning in Ableton Live" 2019) disclose technologies for generating music using deep neural networks.

### SUMMARY

In general music production, the final piece of music is generated through the repeated execution of multiple processes, such as arranging (e.g., adding performance parts) or mixing multiple tracks. However, in conventional music production utilizing pre-trained models such as deep neural networks, music is produced through a single process in response to user instructions. Consequently, it is difficult to iterate through various edits while maintaining musical consistency (i.e., a sense of unity). In view of the above circumstances, one aspect of the present disclosure aims to iterate processing of music data while maintaining musical consistency.

To solve the above problems, an information processing method according to one aspect of the present disclosure generates first instruction data representing one ore more instructions for one or more processing models from among multiple processing models that perform different types of processing, using a machine-learned generative model, based on first input data containing an instruction from a user regarding processing of music data, and attribute data representing an attribute of music represented by the music data, performs processing indicated by the first instruction data on the music data, using the one or more processing models indicated by the first instruction data from among the multiple processing models, generates second instruction data representing one ore more instructions for one or more processing models from among the multiple processing models, using the generative model, based on second input data containing an instruction from the user regarding processing of the music data on which the processing indicated by the first instruction data has been performed, and the attribute data, and performs processing indicated by the second instruction data on the music data, using the one or more processing models indicated by the second instruction data from among the multiple processing models.

An information processing system according to one aspect of the present disclosure includes an instruction data generator and a music data processor, wherein the instruction data generator is configured to generate first instruction data representing one ore more instructions for one or more processing models from among multiple processing models that perform different types of processing, using a machine-learned generative model, based on first input data containing an instruction from a user regarding processing of music data, and attribute data representing an attribute of music represented by the music data, the music data processor is configured to perform processing indicated by the first instruction data on the music data, using the one or more processing models indicated by the first instruction data from among the multiple processing models, the instruction data generator is configured to generate second instruction data representing one ore more instructions for one or more processing models from among the multiple processing models, using the generative model, based on second input data containing an instruction from the user regarding processing of the music data on which the processing indicated by the first instruction data has been performed, and the attribute data, and the music data processor is configured to perform processing indicated by the second instruction data on the music data, using the one or more processing models indicated by the second instruction data from among the multiple processing models.

A non-transitory computer-readable medium storing a program according to one aspect of the present disclosure causes a computer system to execute an information processing method. The information processing method generates first instruction data representing one ore more instructions for one or more processing models from among multiple processing models that perform different types of processing, using a machine-learned generative model, based on first input data containing an instruction from a user regarding processing of music data, and attribute data representing an attribute of music represented by the music data, performs processing indicated by the first instruction data on the music data, using the one or more processing models indicated by the first instruction data from among the multiple processing models, generates second instruction data representing one ore more instructions for one or more processing models from among the multiple processing models, using the generative model, based on second input data containing an instruction from the user regarding processing of the music data on which the processing indicated by the first instruction data has been performed, and the attribute data, and performs processing indicated by the second instruction data on the music data, using the one or more processing models indicated by the second instruction data from among the multiple processing models.

### BRIEF DESCRIPTION OF THE DRAWINGS

FIG. 1 is a block diagram illustrating the configuration of an information processing system in a first embodiment.

FIG. 2 is a schematic diagram of an interactive screen.

FIG. 3 is a block diagram illustrating the functional configuration of the information processing system.

FIG. 4 is a block diagram of an instruction data generation unit.

FIG. 5 is a schematic diagram of attribute data.

FIG. 6 is a flowchart of music data processing.

FIG. 7 is an explanatory diagram regarding the repetition of unit process.

FIG. 8 is a block diagram illustrating the functional configuration of an information processing system in a second embodiment.

### DETAILED DESCRIPTION OF EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

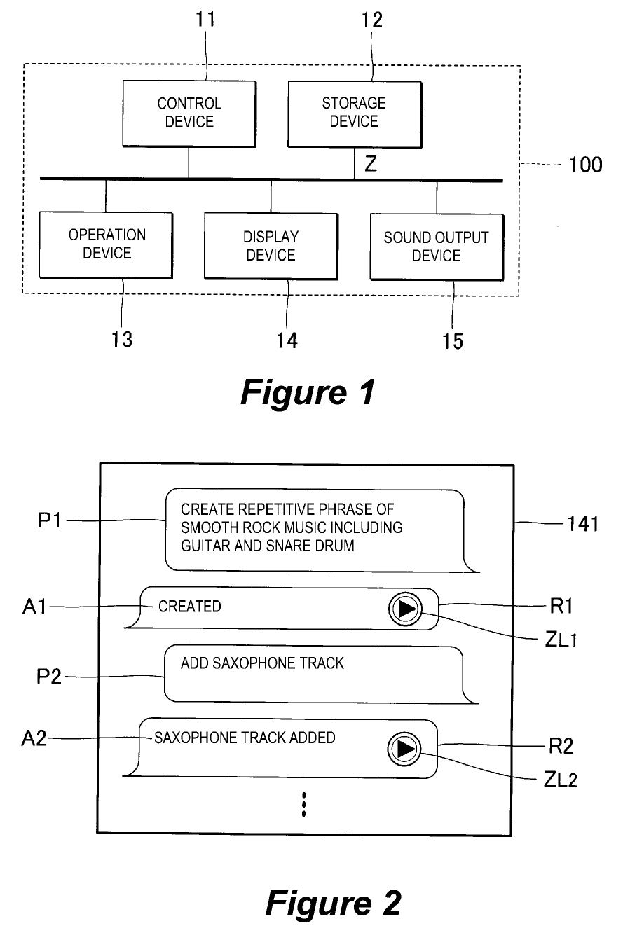

FIG. 1 is a block diagram illustrating the configuration of the information processing system 100 in the first embodiment. The information processing system 100 is a computer system for processing music data Z representing music. The music data Z is a file in any format, such as MP3 (MPEG-1 Audio Layer 3), WAV (Waveform Audio File Format), or AAC (Advanced Audio Coding). The processing of the music data Z includes, for example, processing to newly generate music data Z and processing to edit pre-generated music data Z.

The information processing system 100 includes a control device or electronic controller 11, a storage device or computer memory 12, an operation device or user interface 13, a display device or display 14, and a sound or audio output device 15. The information processing system 100 is implemented by an information device such as a smartphone, a tablet device, or a personal computer. Furthermore, the information processing system 100 can be implemented as a single device or as multiple devices configured as separate units.

The control device or electronic controller 11 includes one or more processors that control the various elements of the information processing system 100. For example, the control device or electronic controller 11 is configured with one or more types of processors, such as a CPU (Central Processing Unit), GPU (Graphics Processing Unit), SPU (Sound Processing Unit), DSP (Digital Signal Processor), FPGA (Field Programmable Gate Array), or ASIC (Application Specific Integrated Circuit).

The storage device 12 includes one or more memories that store the program executed by the control device 11 and various types of data used by the control device 11. The storage device 12 includes a known recording medium, such as a magnetic recording medium or a semiconductor recording medium. The storage device 12 can also include a combination of multiple types of recording media. Furthermore, a portable recording medium that can be attached to or detached from the information processing system 100, or a recording medium (e.g., cloud storage) to which the control device 11 can write or from which it can read via a communication network, can be used as the storage device 12.

The sound output device 15 emits sound waves under the control of the control device 11. In other words, the sound output device 15 outputs audible sound. For example, a speaker or headphones can be used as the sound output device 15. For example, the sound output device 15 emits the playback sound of the music represented by the music data Z.

The operation device 13 includes an input device that receives instructions from the user. The operation device 13 can, for example , be a control element or operation member operated by the user, or a touch panel that detects contact by the user. The display device 14 displays various images under the control of the control device 11. The display device 14 includes a display panel such as an LCD panel or an OLED (Organic Light Emitting Diode) panel.

FIG. 2 is a schematic diagram of an interactive screen 141 displayed on the display device 14. The interactive screen 141 is a dialog-based screen that the user refers to for the processing and playback of the music data Z. The interactive screen 141 includes instructions P (P1, P2, ...) from the user and responses R (R1, R2, ...) from the information processing system 100 to the instructions P.

The instructions P are instructions (prompts) entered by the user through operation of the operation device 13. Specifically, the instructions P are natural language strings representing requests made by the user. The responses R include answers A (A1, A2, ...) to the user's instructions P, and links ZL (ZL1, ZL2, ...) for accessing the music data Z that has been processed according to the instructions P. The answers A are natural language strings corresponding to the instructions P. When the user selects a link ZL by operating the operation device 13, the music of the music data Z corresponding to the link ZL is played back by the sound output device 15.

The pair of the instruction P and the response R is repeated multiple times. The user inputs their own requests or conditions regarding the music data Z as the instruction P and instructs the playback of the music data Z while referring to the answer A of the response R corresponding to the instruction P. The user inputs additional requests or conditions as the instruction P based on the results of listening to the playback of the music data Z. As a result of the dialogue described above being repeated multiple times, the music data Z that cumulatively reflects the user's instructions P is generated.

FIG. 2 illustrates a case where a response R1 is generated in response to a user instruction P1 stating, "Create repetitive phrase of smooth rock music including guitar and snare drum." The response R1 includes an answer A1 stating "Created" in response to the instruction P1, and a link ZL1 to the music data Z corresponding to the instruction P1. If the user, feeling that the newly generated music data Z is lacking, enters an instruction P2, "Add saxophone track," a response R2 is generated. The response R2 includes an answer A2, "Saxophone track added," in response to the instruction P2, and a link ZL2 to the music data Z with the saxophone track added in accordance with the instruction P2. As illustrated in the examples above, the user's initial instruction P1 is an instruction to generate music data Z, and the user's subsequent instruction P2 is an instruction to edit the already generated music data Z. Editing of the already generated music data Z is repeated multiple times.

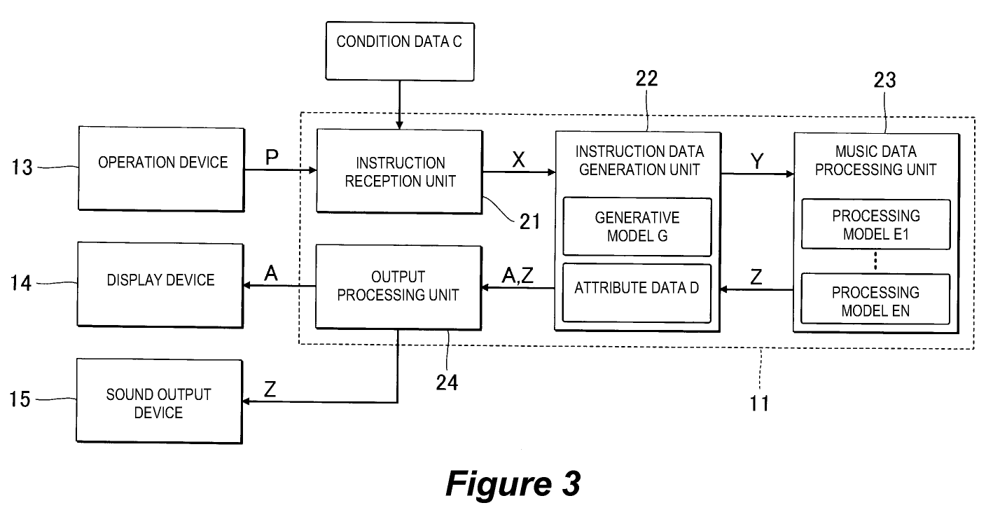

FIG. 3 is a block diagram illustrating the functional configuration of the information processing system 100. By executing a program stored in the storage device 12, the control device or electronic controller 11 (one or more processors) implements multiple functions (an instruction reception unit or instruction receiver 21, an instruction data generation unit or instruction data generator 22, a music data processing unit or music data processor 23, and an output processing unit or output processor 24) for processing music data Z in response to the instructions from the user. Thus, in the illustrated embodiment, the control device or electronic controller 11 (one or more processors) serves as the instruction reception unit 21, the instruction data generation unit 22, the music data processing unit 23, and the output processing unit 24, as described in detail later.

As illustrated in FIG. 3, the processing performed by the control device 11 utilizes a machine-learned generative model G. The generative model G is, for example, an interactive large language model (LLM: Large Language Models) trained specifically for processing tasks involving natural language. For example, a natural language processing model implemented using a Transformer with a self-attention mechanism is illustrated as the generative model G.

The Transformer is disclosed, for example, in Ashish Vaswani, Noam Shazeer, Niki Parmar, Jakob Uszkoreit, Llion Jones, Aidan N. Gomez, Lukasz Kaiser, and Illia Polosukhin, "Attention Is All You Need," 31st Conference on Neural Information Processing Systems (NIPS 2017). Furthermore, as the generative model G, for example, MEGA (Moving Average Equipped Gated Attention), which is a type of Transformer, can be adopted. MEGA is disclosed, for example, in Ma, C. Zhou, X. Kong, J. He, L. Gui, G. Neubig, J. May, and L. Zettlemoyer, "Mega: moving average equipped gated attention," arXiv:2209.10655, 2022.

The instruction reception unit 21 receives the instruction P from the user regarding the processing (generation or editing) of the music data Z. Specifically, the instruction reception unit 21 generates input data X including the user's instruction P and condition data C. The condition data C is data that specifies conditions regarding the operation of the generative model G and is stored in advance in the storage device 12.

Specifically, the condition data C is natural language strings (prompt) that specify:
(1) conditions regarding the functions that the generative model G should realize with respect to the input data X,
(2) constraints regarding the operation of the generative model G,
(3) the formats of input and output for the generative model G,

and so on. The instruction reception unit 21 generates the input data X by appending or inserting the instruction P from the user into the condition data C. With this configuration, the generative model G can be operated under the conditions specified by the condition data C.

The music data processing unit 23 selectively performs multiple types of processing related to the music data Z. Specifically, the music data processing unit 23 selectively utilizes N processing models E1 to EN (where N is a natural number of 2 or more) that perform different types of processing (tasks) to perform processing on the music data Z.

Each processing model En (n = 1 to N) is a backend model for implementing the processing corresponding to the processing model En. Specifically, the processing models En corresponding to diverse processing, such as the generation of the music data Z, the addition of performance parts (tracks) to the music data Z, the deletion of performance parts from the music data Z, the regeneration of specific sections of the music represented by the music data Z, the addition of sound effects to the music data Z, changing the pitch of the music represented by the music data Z (pitch shifting), or changing the performance speed (tempo) of the music represented by the music data Z, and the like, are utilized in processing the music data Z by the music data processing unit 23.

Each processing model En is implemented, for example, by a deep neural network or various signal processing techniques. For example, a generative adversarial network (GAN: Generative Adversarial Network), a variational autoencoders (VAE: Variational AutoEncoder), or a Transformer is used for generating the music data Z or adding the performance parts. To remove the performance parts, a sound source separation model utilizing a convolutional neural network, such as U-Net, is used, for example. To regenerate specific segments of the music data Z, a Transformer or a recurrent neural network (RNN: Recurrent Neural Network) is used, for example. To add sound effects, effect-adding models for adding sound effects, such as reverb or echo, are used. Furthermore, to change the pitch or tempo, time-series models, such as a recurrent neural network, are used.

The instruction data generation unit 22 uses the machine-learned generative model G to generate instruction data Y corresponding to the aforementioned input data X. The instruction data Y is data representing an instruction for operation directed at one processing model En of the N processing models E1 to EN in the music data processing unit 23. Specifically, the instruction data Y includes a designation of one processing model En of the N processing models E1 to EN, and a plurality of variables that define the conditions for the processing to be performed by the processing model En.

The specification of the processing model En by the instruction data Y corresponds to an instruction for the processing to be performed on the music data Z. That is, the instruction data Y instructs processing, such as the generation of the music data Z, the addition of performance parts to the music data Z, the deletion of performance parts from the music data Z, the regeneration of specific sections of the music represented by the music data Z, the addition of sound effects to the music data Z, changing the pitch of the music represented by the music data Z, or changing the performance speed (tempo) of the music represented by the music data Z.

The music data processing unit 23 performs the processing indicated by the instruction data Y on the music data Z. Specifically, the music data processing unit 23 uses the processing model En indicated by the instruction data Y from among the N processing models E1 to EN to perform the processing indicated by the instruction data Y on the music data Z.

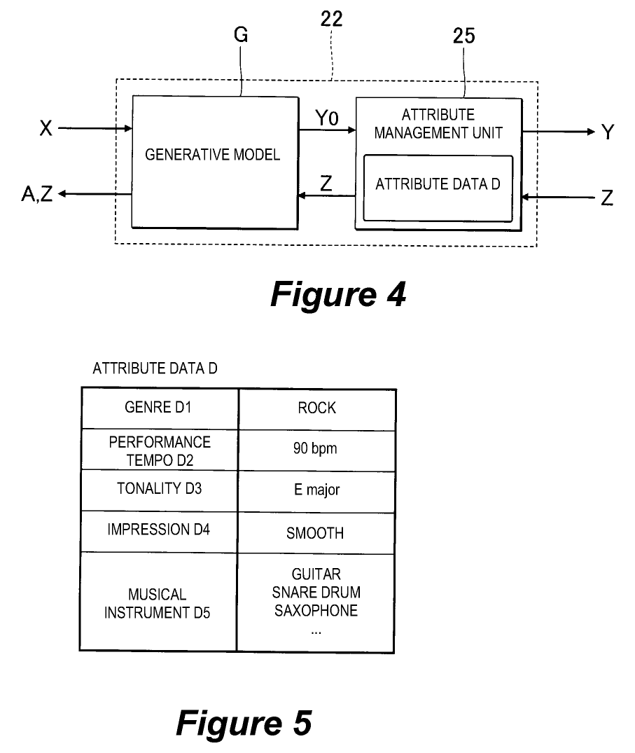

As described above, the instructions P from the user are generated repeatedly. The instruction data generation unit 22 generates the instruction data Y each time the instruction reception unit 21 receives the instruction P. In other words, the instruction data generation unit 22 generates the instruction data Y repeatedly. FIG. 4 is a block diagram of the instruction data generation unit 22. The instruction data generation unit 22 includes the generative model G and an attribute management unit or attribute manager 25.

The generative model G generates instruction data Y0 by processing the input data X. The instruction data Y0 is data that instructs performance of processing corresponding to the instruction P from the user under conditions specified by the condition data C. Specifically, the instruction data Y0 is data that instructs operation corresponding to the instruction P to a processing model En suitable for realizing the user's instruction P from among the N processing models E1 to EN of the music data processing unit 23. For example, the instruction data Y0 includes the specification of one processing model En from among the N processing models E1 to EN, and a plurality of variables that define the conditions for the processing to be performed by the processing model En. The generation of the instruction data Y0 by the generative model G is repeated each time the instruction P from the user is received.

Furthermore, the generative model G generates the answer A by processing the music data Z that has been processed by the music data processing unit 23. That is, the response R is generated that includes the answer A to the instruction P from the user and the music data Z corresponding to the instruction P. Note that the generative model G can generate the answer A from the instruction P included in the input data X.

The output processing unit 24 shown in FIG. 3 controls the output of the response R. Specifically, the output processing unit 24 displays the answer A and the link ZL to the music data Z contained in the response R on the interactive screen 141 of the display device 14. Furthermore, when the user selects the link ZL on the interactive screen 141, the output processing unit 24 plays the music of the music data Z corresponding to the link ZL via the sound output device 15.

The attribute management unit 25 shown in FIG. 4 generates the instruction data Y from the instruction data Y0. The instruction data Y is data in which the attributes of the music represented by the music data Z are reflected in the instruction data Y0. The attributes of the music are characteristics or properties of the music. The attribute management unit 25 generates the instruction data Y, for example, by incorporating the attributes of the music represented by attribute data D into multiple variables (e.g., arguments) of the instruction data Y0. The attribute data D is used in the generation of the instruction data Y by the attribute management unit 25. The attribute data D is stored in the storage device 12.

FIG. 5 is a schematic diagram of the attribute data D. The attribute data D is a table (Global Attribute Table) representing each of multiple attributes related to the music data Z. Specifically, the attribute data D includes genre D1, performance tempo D2, tonality (key) D3, impression (mood) D4, and musical instruments D5 for the music represented by the music data Z.

The genre D1 is a classification that categorizes the music according to its musical style or characteristics. For example, the genre D1, such as rock, pop, jazz, or classical, is specified by the attribute data D. The performance tempo D2 is the speed at which the music is performed. The tonality D3 refers to the structure of a musical scale based on a tonic (fundamental note) that serves as a reference for the progression of the music. Furthermore, the impression D4 is the subjective or emotional atmosphere perceived by the listener from the music based on factors, such as melody, rhythm, or timbre. The musical instrument D5 is musical instruments used to perform the music. The attribute management unit 25 generates the instruction data Y by appending the multiple attributes (D1 to D5) exemplified above to the instruction data Y0.

As described above, the instruction data generation unit 22 generates the instruction data Y, which represents the instruction for one processing model En of the N processing models E1 to EN, based on the input data X containing the instruction P from the user and the attribute data D representing the attributes of the music represented by the music data Z, using the generative model G. As mentioned above, the generation of the instruction data Y by the instruction data generation unit 22 is repeated multiple times. In the first embodiment, the same attribute data D is used for the multiple generations of the instruction data Y. Therefore, processing of the music data Z can be repeated while maintaining musical consistency (i.e., a sense of unity).

Furthermore, the attribute management unit 25 updates the attribute data D. Specifically, the attribute management unit 25 partially updates the attribute data D each time the music data processing unit 23 processes the music data Z. For example, the attribute management unit 25 estimates each attribute (D1 to D5) indicated by the attribute data D by analyzing the music data Z that has been processed by the music data processing unit 23, and updates the attribute data D according to the estimation results. For example, each attribute in the attribute data D is extracted from music data Z newly generated in response to an initial instruction P from the user, or from music data Z edited in response to one or more subsequent instructions from the user.

Note that the instruction P received by the instruction reception unit 21 from the user includes attributes regarding the music requested by the user. The attribute management unit 25 partially updates the attribute data D in response to the instruction P from the user. For example, if an instruction P such as "Create repetitive phrase of smooth rock music including guitar and snare drum," as illustrated in FIG. 2, is issued, the attribute management unit 25 updates the genre D1 in the attribute data D to "rock," updates the impression D4 to "smooth," and updates the musical instrument D5 to "guitar" and "snare drum."

As illustrated in the examples above, in the first embodiment, the attribute data D is partially updated for each processing performed on the music data Z. Specifically, the attribute management unit 25 updates the attribute data D based on the instruction P from the user and the music data Z that has been processed by the music data processing unit 23. Therefore, it is possible to achieve both musical consistency in the music data Z and changes in the music data Z resulting from repetitive processing. In the first embodiment, in particular, since the user's instruction P and the processed music data Z are reflected in the attribute data D, it is possible to reflect the user's intent and the results of processing the music data Z in the attribute data D.

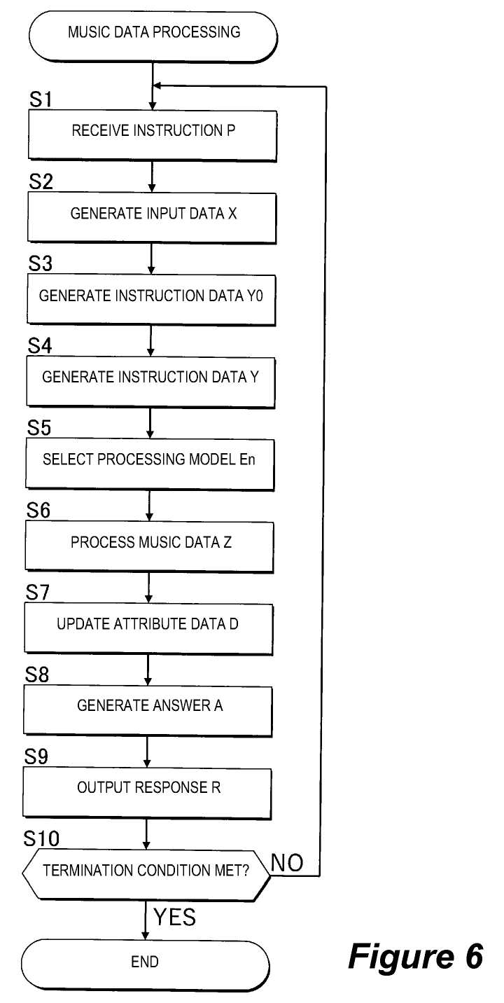

FIG. 6 is a flowchart of the processing (hereinafter referred to as "music data processing") performed by the control device 11. For example, the music data processing is initiated in response to the user's instruction P given to the operation device 13. When the music data processing begins, the control device 11 (the instruction reception unit 21) receives the instruction P from the user via the operation device 13 (S1). The control device 11 (the instruction reception unit 21) generates the input data X including the instruction P and the condition data C (S2).

The control device 11 (the instruction data generation unit 22) generates the instruction data Y0 by processing the input data X using the generative model G (S3). The control device 11 (the attribute management unit 25) generates the instruction data Y by adding the attributes of the music represented by the attribute data D to the instruction data Y0. As described above, the control device 11 uses the machine-learned generative model G to generate the instruction data Y based on the input data X and the attribute data D (S3, S4).

The control device 11 (the music data processing unit 23) performs the processing indicated by the instruction data Y (S5, S6). Specifically, first, the control device 11 selects the processing model En specified by the instruction data Y from among the N processing models E1 to EN (S5). The control device 11 processes the music data Z using the processing model En (S6). The control device 11 (the attribute management unit 25) updates the attribute data D according to the instruction P from the user and the processed music data Z (S7).

The control device 11 (the generative model G) generates the answer A based on the processed music data Z or the user's instruction P (S8). The control device 11 (the output processing unit 24) outputs the response R, which includes the music data Z and the answer A, to the user (S9). Specifically, the control device 11 displays the answer A and the link ZL on the interactive screen 141 of the display device 14. Furthermore, when the user selects the link ZL, the control device 11 plays the music of the music data Z via the sound output device 15.

The control device 11 determines whether a predetermined termination condition has been met (S10). The termination condition is, for example, that the user has instructed the termination of the processing by operating the operation device 13. If the termination condition is not met (S10: NO), the control device 11 proceeds the processing to step S1. As described above, a series of processes (hereinafter referred to as "unit process Um") including the generation of the input data X (S1, S2), the generation of the instruction data Y (S3, S4), the processing of the music data Z (S5, S6), the updating of the attribute data D (S7), and the output of the response R (S8, S9) is repeated until the termination condition is met (S10: YES). When the termination condition is satisfied (S10: YES), the control device 11 terminates the music data processing.

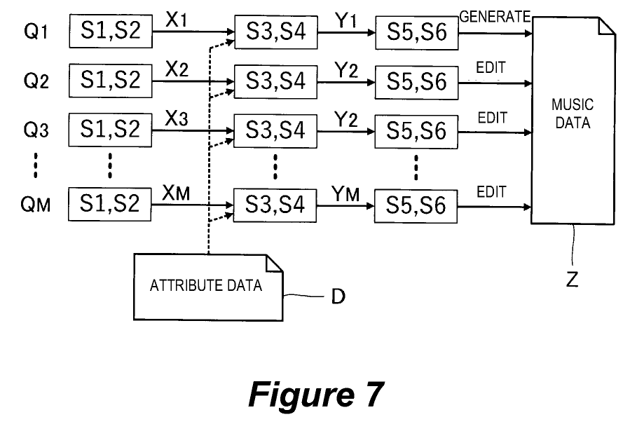

FIG. 7 is a diagram illustrating the repetition of the unit process Um. As shown in FIG. 7, the unit process Um (m = 1 to M) is repeated multiple times (M times). The number M of the unit process Um is arbitrary. The m-th unit process Um includes the generation of input data Xm (S1, S2), the generation of instruction data Ym (S3, S4), and the processing of the music data Z (S5, S6). The attribute data D is commonly used across the multiple unit processes Um.

Consider any unit process Um1 (m1 = 0 to M-1) among the multiple unit processes Um, and a unit process Um2 (m2 = 1 to M, m2 ≠ m1) immediately following the unit process Um1. The control device 11
(1) generates instruction data Ym1 based on input data Xm1, which includes an instruction Pm1 from a user, and attribute data D (S1, S2),
(2) performs processing indicated by the instruction data Ym1 on the music data Z (S3, S4),
(3) generates instruction data Ym2 based on input data Xm2, which includes an instruction Pm2 from the user regarding processing of the music data Z on which the processing indicated by the instruction data Ym1 has been performed, and the attribute data D (S1, S2), and
(4) performing processing indicated by the instruction data Ym2 on the music data Z (S3, S4).

In the above description, the input data Xm1 is an example of "first input data," and the instruction data Ym1 is an example of "first instruction data." Furthermore, the input data Xm2 is an example of "second input data," and the instruction data Ym2 is an example of "second instruction data."

### B: Second Embodiment

The second embodiment will now be described. Note that for elements whose functions are the same as those in the first embodiment in each of the aspects illustrated below, the same reference numerals as in the description of the first embodiment are used, and detailed descriptions of such elements are appropriately omitted.

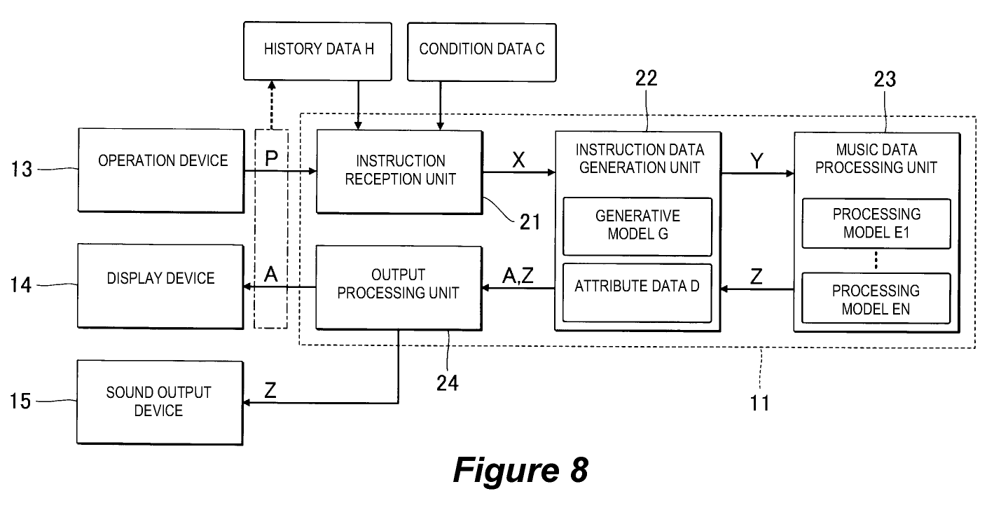

FIG. 8 is a block diagram illustrating the functional configuration of an information processing system 100 in the second embodiment. As illustrated in FIG. 8, in the second embodiment, history data H is used by an instruction reception unit 21 to generate input data X. Specifically, the instruction reception unit 21 of the second embodiment generates the input data X including an instruction P from a user, condition data C, and the history data H (S1, S2 in FIG. 6).

The history data H is data representing a dialogue history between the user and the information processing system 100. Specifically, the history data H represents the dialogue history including instructions P issued by the user and answers A from a generative model G to the instructions P. That is, the history data H represents a time series in which the instructions P and the answers A are arranged alternately. The history data H is stored in a storage device 12.

A control device 11 (the instruction reception unit 21) updates the history data H each time the instruction P or the response A is generated. Specifically, the control device 11 adds the instruction P to the history data H each time it receives the instruction P from the user, and adds the answer A to the history data H each time the answer A is generated by the generative model G.

The second embodiment achieves the same effects as the first embodiment. Furthermore, in the second embodiment, it is possible to reflect the dialogue history which includes the instructions P from the user and the answers A generated by the generative model G to the processing of music data Z.

### C: Variations

Specific variations added to the aspects illustrated above are illustrated below. Two or more aspects arbitrarily selected from the following illustrations can be appropriately combined to the extent that they do not conflict with one another.

(1) In each of the aforementioned embodiments, an example is illustrated in which the instruction data Y specifies a single processing model En from among the N processing models E1 to EN of the music data processing unit 23. However, the present disclosure is not limited to this. The instruction data Y can specify multiple processing models En to be used for processing of the music data Z. For example, the instruction data Y specifies multiple processing models En to be performed sequentially on the music data Z. That is, the instruction data Y specifies the chronological order of processing to be performed on the music data Z. In particular, the instruction data Y is data representing multiple instructions for operation directed at the multiple processing models En of the N processing models E1 to EN in the music data processing unit 23.

The music data processing unit 23 sequentially processes the music data Z using the multiple processing models En specified by the instruction data Y. For example, when the instruction data Y specifies processing models En1 and En2 (n1, n2 = 1 to N, n1 ≠ n2), the music data processing unit 23 performs processing using the processing model En1 on the music data Z, and then performs processing using the processing model En2 on the processed music data Z. In other words, multiple processes are performed cumulatively on the music data Z.

(2) In each of the aforementioned embodiments, the instruction reception unit 21 is described as an element separate from the generative model G. However, the present disclosure is not limited to this. The functions of the instruction reception unit 21 can be implemented by the generative model G. For example, by instructing the generative model G via the condition data C to perform the operation of generating the input data X corresponding to the instruction P, it is possible to implement the functions of the instruction reception unit 21 in each of the aforementioned embodiments using the generative model G.

Furthermore, in each of the aforementioned embodiments, the attribute management unit 25 is described as an element separate from the generative model G. However, the present disclosure is not limited to this. The functions of the attribute management unit 25 can be implemented by the generative model G. For example, by instructing the generative model G via the condition data C to perform the operations of generating the instruction data Y based on the attribute data D and updating the attribute data D based on the instruction P from the user or the processed music data Z, it is possible to implement the functions of the attribute management unit 25 in each of the aforementioned embodiments using the generative model G.

As can be understood from the above examples, the instruction data generation unit 22 can be broadly described as an element that generates the instruction data Y, which represents one or more instructions for one or more processing models En from among the N processing models E1 to EN that perform different types of processing, using a machine-learned generative model G, based on the input data X containing the instruction P from the user and the attribute data D representing the attributes of the music represented by the music data Z. The function realized by the generative model G includes part or all of the process of generating the instruction data Y from the user's instruction P.

(3) In each of the aforementioned embodiments, the input data X including the user's instruction P is illustrated. However, the elements of the input data X are not limited to the above examples. For example, the input data X can include an audio signal along with the user's instruction P. The audio signal is a signal representing various sounds. For example, an audio signal representing the sound of a musical performance or singing can be input into the input data X together with the instruction P. The generative model G generates the instruction data Y, which represents an instruction to perform processing corresponding to the instruction P on the audio signal. As can be understood from the above description, the generative model G can be a multimodal AI capable of processing data in multiple different formats.

(4) The information processing system 100 in each of the aforementioned embodiments can be implemented by a server device that communicates with terminal devices such as smartphones or tablet devices. The information processing system 100 receives the instruction P from the user via a communication network from the terminal device. The information processing system 100 generates the response R (the answer A and the music data Z) by operating in the same manner as in each of the aforementioned embodiments, and transmits the response R to the terminal device.

Furthermore, in an embodiment in which the instruction reception unit 21 is incorporated into the terminal device, the instruction reception unit 21 is omitted from the information processing system 100. That is, the information processing system 100 receives the input data X generated by the instruction reception unit 21 of the terminal device. Furthermore, in an embodiment in which the output processing unit 24 is incorporated into the terminal device, the output processing unit 24 is omitted from the information processing system 100.

(5) The functions of the information processing system 100 illustrated above are realized, as described earlier, through the cooperation of a single or multiple processors forming the control device 11 and a program stored in the storage device 12. The program related to the present disclosure can be provided in a form stored on a computer-readable recording medium and installed on a computer. The recording medium is, for example, a non-transitory recording medium, a preferred example of which includes an optical recording medium (optical disc), such as a CD-ROM, but can also include any known form of recording medium, such as semiconductor recording medium or magnetic recording medium. Note that a non-transitory recording medium includes any recording medium other than a transitory propagating signal, and volatile recording media are not excluded. Furthermore, in a configuration where a distribution device distributes the program via a communication network, the storage medium in which the program is stored in the distribution device corresponds to the aforementioned non-transitory recording medium.

### D: Additional Statement

For example, from the embodiments illustrated above, the following configuration can be understood.

An information processing method according to one aspect (first aspect) of the present disclosure generates first instruction data representing instructions for one or more processing models from among multiple processing models that perform different types of processing, using a machine-learned generative model, based on first input data containing an instruction from a user regarding processing of music data, and attribute data representing an attribute of music represented by the music data, performs processing indicated by the first instruction data on the music data, using the one or more processing models indicated by the first instruction data from among the multiple processing models, generates second instruction data representing instructions for one or more processing models from among the multiple processing models, using the generative model, based on second input data containing an instruction from the user regarding processing of the music data on which the processing indicated by the first instruction data has been performed, and the attribute data, and performs processing indicated by the second instruction data on the music data, using the one or more processing models indicated by the second instruction data from among the multiple processing models. According to the aspect described above, the same attribute data representing the attribute of the music represented by the music data is used in both the generation of the first instruction data based on the first input data and the generation of the second instruction data based on the second input data. Therefore, the processing of the music data can be repeated while maintaining musical consistency (i.e., a sense of unity).

In a specific example (second aspect) of first aspect, the attribute data is further partially updated for each processing on the music data. According to the aspect described above, the attribute data is partially updated for each processing on the music data. Therefore, it is possible to achieve both musical consistency in the music data and changes in the music data resulting from repetitive processing.

In a specific example (third aspect) of second aspect, in the updating of the attribute data, the attribute data is updated based on an instruction from the user and the music data after performance of the processing indicated by the first instruction data or the second instruction data. According to the aspect described above, since the user's instruction and the processed music data are reflected in the attribute data, it is possible to reflect the user's intent and the results of processing the music data in the attribute data.

In a specific example (fourth aspect) of any one of first to third aspects, the attribute data includes at least one of genre, tempo, tonality, impression, or musical instrument of the music.

In a specific example (fifth aspect) of any one of first to fourth aspects, the first instruction data and the second instruction data each instruct, as processing on the music data, an addition of a performance part to the music, a deletion of a performance part, a regeneration of a specific section of the music, an addition of sound effects, a change in pitch, or a change in performance speed.

In a specific example (sixth aspect) of any one of first to fifth aspects, the first input data and the second input data each include history data representing a dialogue history having an instruction from the user and an answer from the generative model to the instruction. According to the aspect described above, it is possible to reflect the dialogue history which includes the instruction from the user and the response generated by the generative model to the processing of the music data.

In a specific example (seventh aspect) of any one of first to sixth aspects, the first input data and the second input data each further include condition data specifying a condition regarding an operation of the generative model. According to the aspect described above, the generative model can be operated under the condition specified by the condition data.

An information processing system according to one aspect (eighth aspect) of the present disclosure is an information processing system comprising an instruction data generation unit and a music data processing unit, wherein the instruction data generation unit generates first instruction data representing instructions for one or more processing models from among multiple processing models that perform different types of processing, using a machine-learned generative model, based on first input data containing an instruction from a user regarding processing of music data, and attribute data representing an attribute of music represented by the music data, the music data processing unit performs processing indicated by the first instruction data on the music data, using the one or more processing models indicated by the first instruction data from among the multiple processing models, the instruction data generation unit generates second instruction data representing instructions for one or more processing models from among the multiple processing models, using the generative model, based on second input data containing an instruction from the user regarding processing of the music data on which the processing indicated by the first instruction data has been performed, and the attribute data, and the music data processing unit performs processing indicated by the second instruction data on the music data, using the one or more processing models indicated by the second instruction data from among the multiple processing models.

A program according to one aspect (ninth aspect) of the present disclosure is a program that causes a computer system to function as an instruction data generation unit and a music data processing unit, wherein the instruction data generation unit generates first instruction data representing instructions for one or more processing models from among multiple processing models that perform different types of processing, using a machine-learned generative model, based on first input data containing an instruction from a user regarding processing of music data, and attribute data representing an attribute of music represented by the music data, the music data processing unit performs processing indicated by the first instruction data on the music data, using the one or more processing models indicated by the first instruction data from among the multiple processing models, the instruction data generation unit generates second instruction data representing instructions for one or more processing models from among the multiple processing models, using the generative model, based on second input data containing an instruction from the user regarding processing of the music data on which the processing indicated by the first instruction data has been performed, and the attribute data, and the music data processing unit performs processing indicated by the second instruction data on the music data, using the one or more processing models indicated by the second instruction data from among the multiple processing models.

What is claimed is:

1. An information processing method executed by a computer system, the information processing method comprising:
generating first instruction data representing one or more instructions for one or more processing models from among multiple processing models that perform different types of processing, using a machine-learned generative model, based on first input data containing an instruction from a user regarding processing of music data, and attribute data representing an attribute of music represented by the music data;
performing processing indicated by the first instruction data on the music data, using the one or more processing models indicated by the first instruction data from among the multiple processing models;
generating second instruction data representing one or more instructions for one or more processing models from among the multiple processing models, using the generative model, based on second input data containing an instruction from the user regarding processing of the music data on which the processing indicated by the first instruction data has been performed, and the attribute data; and
performing processing indicated by the second instruction data on the music data, using the one or more processing models indicated by the second instruction data from among the multiple processing models.

2. The information processing method according to claim 1, further comprising
partially updating the attribute data for each processing on the music data.

3. The information processing method according to claim 2, wherein
the updating of the attribute data includes updating the attribute data based on an instruction from the user and the music data on which the processing indicated by the first instruction data or the second instruction data has been performed.

4. The information processing method according to claim 1, wherein
the attribute data includes at least one of genre, tempo, tonality, impression, or musical instrument of the music.

5. The information processing method according to claim 1, wherein
the first instruction data and the second instruction data each instruct, as processing on the music data, an addition of a performance part to the music, a deletion of a performance part, a regeneration of a specific section of the music, an addition of sound effects, a change in pitch, or a change in performance speed.

6. The information processing method according to claim 1, wherein
the first input data and the second input data each include history data representing a dialogue history having an instruction from the user and an answer from the generative model to the instruction.

7. The information processing method according to claim 1, wherein
the first input data and the second input data each further include condition data specifying a condition regarding an operation of the generative model.

8. An information processing system comprising:
an instruction data generator; and
a music data processor, wherein
the instruction data generator is configured to generate first instruction data representing one or more instructions for one or more processing models from among multiple processing models that perform different types of processing, using a machine-learned generative model, based on first input data containing an instruction from a user regarding processing of music data, and attribute data representing an attribute of music represented by the music data,
the music data processor is configured to perform processing indicated by the first instruction data on the music data, using the one or more processing models indicated by the first instruction data from among the multiple processing models,
the instruction data generator is configured to generate second instruction data representing one or more instructions for one or more processing models from among the multiple processing models, using the generative model, based on second input data containing an instruction from the user regarding processing of the music data on which the processing indicated by the first instruction data has been performed, and the attribute data, and
the music data processor is configured to perform processing indicated by the second instruction data on the music data, using the one or more processing models indicated by the second instruction data from among the multiple processing models.

9. The information processing system according to claim 8, further comprising
an attribute manager configured to partially update the attribute data for each processing on the music data.

10. The information processing system according to claim 9, wherein
the attribute manager is further configured to update the attribute data based on an instruction from the user and the music data on which the processing indicated by the first instruction data or the second instruction data has been performed.

11. The information processing system according to claim 10, wherein
the attribute data includes at least one of genre, tempo, tonality, impression, or musical instrument of the music.

12. The information processing system according to claim 8, wherein
the first instruction data and the second instruction data each instruct, as processing on the music data, an addition of a performance part to the music, a deletion of a performance part, a regeneration of a specific section of the music, an addition of sound effects, a change in pitch, or a change in performance speed.

13. The information processing system according to claim 8, wherein
the first input data and the second input data each include history data representing a dialogue history having an instruction from the user and an answer from the generative model to the instruction.

14. The information processing system according to claim 8, wherein
the first input data and the second input data each further include condition data specifying a condition regarding an operation of the generative model.

15. A non-transitory computer-readable medium storing a program that causes a computer system to execute an information processing method, the information processing method comprising:
generating first instruction data representing one ore more instructions for one or more processing models from among multiple processing models that perform different types of processing, using a machine-learned generative model, based on first input data containing an instruction from a user regarding processing of music data, and attribute data representing an attribute of music represented by the music data;
performing processing indicated by the first instruction data on the music data, using the one or more processing models indicated by the first instruction data from among the multiple processing models;
generating second instruction data representing one ore more instructions for one or more processing models from among the multiple processing models, using the generative model, based on second input data containing an instruction from the user regarding processing of the music data on which the processing indicated by the first instruction data has been performed, and the attribute data; and
performing processing indicated by the second instruction data on the music data, using the one or more processing models indicated by the second instruction data from among the multiple processing models.
